(19) United States
(12) Patent Application Publication
(10) Pub. No.: US 2026/0216598 A1
(43) Pub. Date: Jul. 30, 2026

(54) IMAGE PROCESSING SYSTEM, IMAGE PROCESSING METHOD, AND PROGRAM

(71) Applicant: Sony Interactive Entertainment Inc., Tokyo (JP)

(72) Inventors: Hirotaka Asayama, Kanagawa (JP); Ryota Ito, Kanagawa (JP); Shoichi Ikenoue, Chiba (JP)

(21) Appl. No.: 19/630,211

(22) Filed: Mar. 26, 2026

Related U.S. Application Data
(63) Continuation of application No. PCT/JP2024/033480, filed on Sep. 19, 2024.

(30) Foreign Application Priority Data
Sep. 29, 2023 (JP) 2023-169760

(51) Int. Cl. A63F 13/52; G06T 7/20; G06T 7/50

(52) U.S. Cl. CPC A63F 13/52; G06T 7/20; G06T 7/50

(57) ABSTRACT

Estimation accuracy of an estimated frame (24) is improved by utilizing virtual space information (27). Provided is an image processing system (1) including at least one processor, in which the processor acquires an n-th processing target frame (20), acquires an n-th input frame (22) in reference to the n-th processing target frame (20), acquires n-th virtual space information (27) which is information regarding a virtual space available for deciding a pixel value of each pixel of the n-th processing target frame, identifies an n-th appearing pixel in reference to (n-1)-th depth information and n-th depth information, and acquires n-th auxiliary information (30) in reference to at least the n-th appearing pixel, the n-th virtual space information (27), n-th accumulated feature information (28), and a machine learning model (422a).

### CROSS-REFERENCE TO RELATED APPLICATIONS

This application is a continuation of International Application No. PCT/JP2024/033480, filed September 19, 2024, which claims the benefit of Japanese Application No. 2023-169760 filed September 29, 2023. This disclosure of the prior application is considered part of the disclosure of this application

The present specification relates to an image processing system, an image processing method, and a program.

### BACKGROUND

A technology (super resolution) of estimating a high quality image in reference to a low quality image with use of a machine learning model has hitherto been known.

### SUMMARY

The present specification discloses the use of a machine learning model having a recursive configuration that uses information regarding past frames, in order to realize super resolution for moving images as exemplified by a game screen.

Moreover, present specification discloses the application of the super resolution to a processing target frame indicating, from a predetermined viewpoint, a virtual space in which one or more objects represented by three-dimensional (3D) data are arranged.

Processing target frames are generated by rendering of 3D data. Rendering is executed based on information regarding a virtual space (hereinafter referred to as the "virtual space information") that is available for deciding the pixel value of each pixel of a virtual image. Virtual space information includes, for example, information regarding a viewpoint for viewing the virtual space, information regarding motion of an object, information regarding color and texture of an object, and information regarding intensity, color, and an illuminating direction of a light source.

The present specification discloses the use of the abovementioned virtual space information to improve estimation accuracy of an estimated frame that is output from a machine learning model. However, the virtual space information may have insufficient reliability, leaving room for improvement in its use.

The present specification has an object to provide an image processing system, an image processing method, and a program that improve estimation accuracy of an estimated frame by utilizing virtual space information.

An image processing system according to the present specification is an image processing system including at least one processor, in which the at least one processor acquires an n-th (n is a natural number equal to or greater than 2) processing target frame indicating, from a predetermined viewpoint, a virtual space in which one or more objects represented by three-dimensional data are arranged, acquires an n-th input frame in reference to the n-th processing target frame, inputs the n-th input frame and (n-1)-th auxiliary information regarding features of first through (n-1)-th input frames to a first machine learning model to acquire n-th accumulated feature information indicating features of the first through n-th input frames that is to be output from the first machine learning model and an n-th estimated frame, acquires n-th virtual space information that is information regarding the virtual space available for deciding a pixel value of each pixel of the n-th processing target frame, acquires (n-1)-th depth information indicating a depth of each pixel of an (n-1)-th processing target frame and n-th depth information indicating a depth of each pixel of the n-th processing target frame, identifies an n-th appearing pixel that is a pixel among pixels of the n-th processing target frame and that is a pixel in which a whole or part of the object that is not displayed in the (n-1)-th processing target frame is displayed, in reference to the (n-1)-th depth information and the n-th depth information, and acquires n-th auxiliary information in reference to at least the n-th appearing pixel, the n-th virtual space information, the n-th accumulated feature information, and a second machine learning model.

### BRIEF DESCRIPTION OF THE DRAWINGS

FIG. 1 is a diagram illustrating an example of a hardware configuration of an image processing system.

FIG. 2 is a diagram illustrating an outline of the image processing system.

FIG. 3 is a functional block diagram illustrating an example of functions implemented by the image processing system.

FIG. 4 is a diagram describing processing in a rendering section.

FIG. 5 is a diagram describing processing in an input frame acquiring section.

FIG. 6A is a flowchart illustrating an example of a flow of processing executed in the image processing system.

FIG. 6B is a flowchart illustrating another example of a flow of processing executed in the image processing system.

FIG. 7 is a functional block diagram illustrating an example of functions implemented by an image processing system according to a modification example.

### DETAILED DESCRIPTION

One example of an implementation of an image processing system according to the present specification is hereinafter described with reference to the drawings.

### 1. Hardware configuration of image processing system

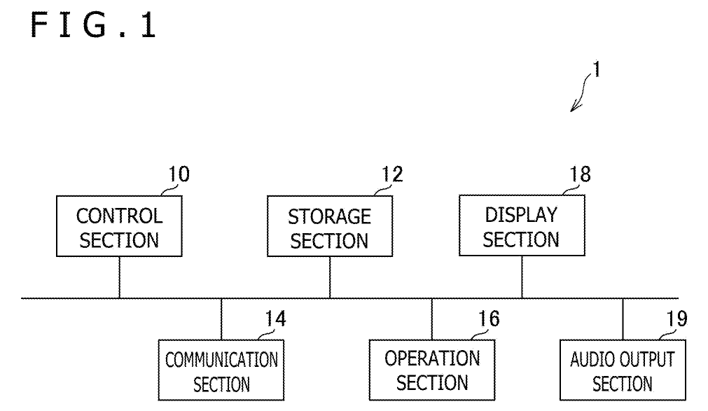

FIG. 1 is a diagram illustrating an example of a hardware configuration of an image processing system 1. The image processing system 1 is, for example, a computer such as a game console (game machine). As illustrated in FIG. 1, the image processing system 1 includes a control section 10, a storage section 12, a communication section 14, an operation section 16, a display section 18, and an audio output section 19.

The control section 10 includes, for example, a program control device such as a central processing unit (CPU) that operates in accordance with a program installed in the image processing system 1. Moreover, the control section 10 also includes a graphics processing unit (GPU) that draws an image in a frame buffer in reference to a graphics command or data supplied from the CPU.

The storage section 12 includes, for example, a main storage device such as a read only memory (ROM) and a random access memory (RAM) and an auxiliary storage device such as a hard disk drive (HDD) and a solid state drive (SSD). The storage section 12 stores therein programs executed by the control section 10, for example. The storage section 12 stores, for example, game programs (game software) in addition to programs for implementing various functions of the image processing system 1 that are to be described later. Moreover, in the storage section 12, an area for a frame buffer in which an image is drawn by the GPU is reserved.

The communication section 14 is, for example, a communication interface such as an Ethernet (registered trademark) module, a wireless local area network (LAN) module, and the like.

The operation section 16 is a user interface such as a keyboard, a mouse, and a controller of a game console, receives operation input made by the user, and outputs a signal indicating contents of the input to the control section 10.

The display section 18 is a display device such as a liquid crystal display and an organic electroluminescence (EL) display and displays various kinds of images in accordance with instructions given by the control section 10.

The audio output section 19 is, for example, a speaker and outputs audio indicated by audio data generated by the image processing system 1.

Note that the image processing system 1 may, in addition to the devices described above, include an optical disk drive that reads an optical disk such as a digital versatile disc-ROM (DVD-ROM) and a Blu-ray (registered trademark) disc, a universal serial bus (USB) port, and the like.

### 2. Outline of image processing system

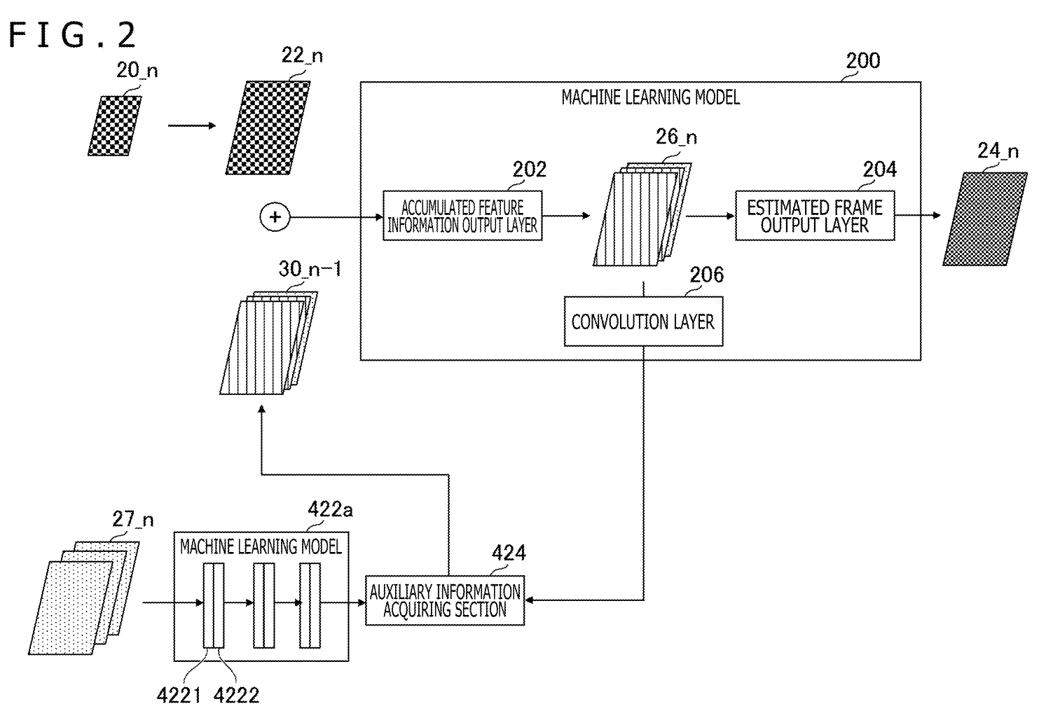

FIG. 2 is a diagram illustrating an outline of the image processing system 1. Here, a case where the image processing system 1 is used for improving the quality of gameplay moving images in a game is illustrated. Gameplay moving images are moving images generated according to the game program executed by the control section 10, user input received by the operation section 16, and the like. Gameplay moving images include a plurality of still images (frames) that are time-series data. The processing executed in the image processing system 1 is mainly as follows.

### 1 Generation of processing target frame

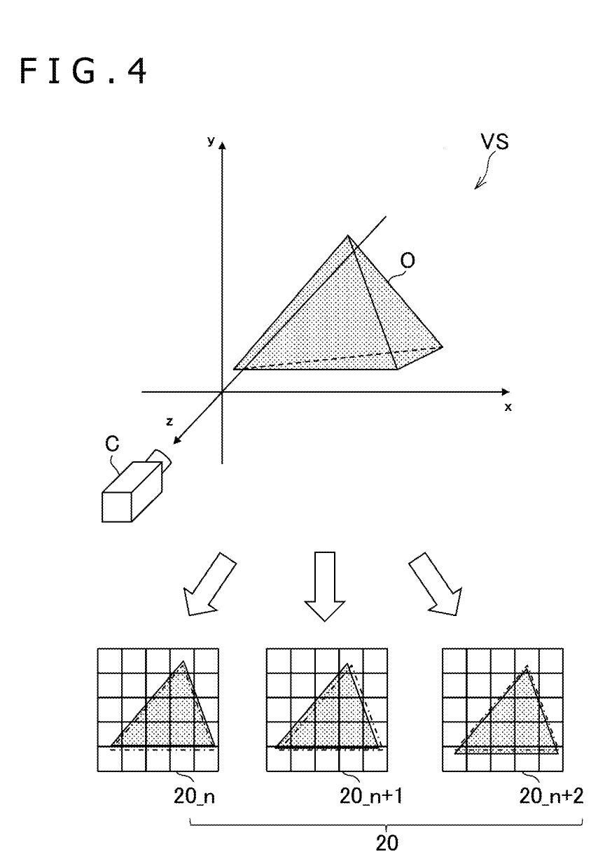

First, the image processing system 1 generates an image (processing target frame) in which one or more game objects are drawn, by executing rendering of 3D data indicating the game objects as viewed from a predetermined viewpoint. The processing target frame is an image having a predetermined pixel count (initial pixel count) and a predetermined image quality (initial image quality). The processing target frame can be said to be an image indicating, from a predetermined viewpoint, a virtual space VS in which the abovementioned one or more game objects represented by 3D data are arranged (see FIG. 4). The processing target frame is generated every predetermined time. The processing target frame has a pixel count of, for example, 1920 × 1080 (1080 p). Each of the generated processing target frames is once stored in the storage section 12 and then subjected to subsequent processing, instead of being directly displayed on the display section 18 without any change. Note that, in the following description, processing targeting an n-th processing target frame 20_n is mainly illustrated, but similar processing is also executed on other processing target frames (that is, n = 2, 3, ..., N).

### 2 Acquisition of input frame

The image processing system 1 acquires a frame (input frame) 22_n that has a pixel count (input pixel count) greater than the initial pixel count, in reference to the acquired processing target frame 20_n. The input pixel count is, for example, 3840 × 2160 (4K). Specifically, the input frame 22_n is generated by enlargement and interpolation processing being executed on the processing target frame 20_n.

Here, note that, while the input frame 22_n has a pixel count greater than the pixel count of the processing target frame 20_n, its image quality is not necessarily improved to a sufficient level. That is, the image quality of a frame does not simply correspond to the pixel count (resolution). The image quality of a frame may, for example, be evaluated in reference to each of the level of the signal/noise (SN) ratio, the level of reproducibility of a spatial frequency, the level of time stability (the amount of artifact and flickering that occur at the time when a plurality of frames are sequentially displayed), and the like in comparison to a reference frame or a comprehensive consideration of these factors.

### 3 Acquisition of estimated frame

The image processing system 1 inputs the input frame 22_n to a machine learning model 200 (first machine learning model), which is a machine learning model, and acquires an estimated frame 24_n. The estimated frame 24_n is an image having a pixel count (estimated pixel count) equal to the input pixel count and an image quality (estimated image quality) equal to or greater than the initial image quality. Here, in addition to the input frame 22_n, (n-1)-th auxiliary information 30_n-1 is input to the machine learning model 200. Details of the (n-1)-th auxiliary information 30_n-1 are described later.

Note that the machine learning model 200 is a model that has learned with use of a plurality of pieces of training data each including a learning input frame having an input pixel count and a learning estimated frame having an estimated pixel count and an estimated image quality.

### 4 Acquisition of accumulated feature information

The machine learning model 200 includes an accumulated feature information output layer 202 that receives, as input, the n-th input frame 22_n and the (n-1)-th auxiliary information 30_n-1 and that outputs n-th accumulated feature information 26_n indicating features of the first through n-th input frames 22 (see FIG. 2). The image processing system 1 acquires the n-th accumulated feature information 26_n. The acquired n-th accumulated feature information 26_n is used for generating the n-th auxiliary information 30_n.

Note that the acquired n-th accumulated feature information 26_n is also stored in the storage section 12 and offered for estimation of an estimated frame 24_n+1 that corresponds to the next processing target frame ((n+1)-th processing target frame) 20_n+1.

As described above, according to the image processing system 1, the estimated frame 24 is estimated with use of the accumulated feature information 26 in which pieces of past information are accumulated, in addition to the input frame 22 corresponding to the current processing target frame 20. This increases the amount of information available for estimation, allowing a high quality estimated frame 24_n to be obtained.

### 5 Acquisition of auxiliary information

As described above, the (n-1)-th accumulated feature information 26_n-1 is information indicating the features of the first through (n-1)-th input frames 22 (hence, the first through (n-1)-th processing target frames 20). Using the (n-1)-th accumulated feature information 26_n-1, in which pieces of information regarding the past processing target frames 20 are accumulated, for estimation of an n-th estimated frame 24_n in this manner increases the amount of information available for estimation, allowing a high quality estimated frame 24_n to be obtained.

However, when any motion or the like of the displayed game object is made between the (n-1)-th processing target frame 20_n-1 and the n-th processing target frame 20_n, if the n-th input frame 22_n and the (n-1)-th accumulated feature information 26_n-1 are input to the machine learning model 200 without any change, such a phenomenon (what is generally called a ghost phenomenon) that an afterimage of the game object that had been displayed in the (n-1)-th processing target frame 20_n-1 is displayed may occur.

In view of this, the image processing system 1 acquires (n-1)-th auxiliary information 30_n-1 in reference to the information (motion vector, depth buffer, and the like) obtained at the time of rendering, with respect to the (n-1)-th accumulated feature information 26_n-1 (see FIG. 2).

As described above, processing target frames 20 are generated by execution of rendering of 3D data. Rendering is executed based on virtual space information 27 which is information regarding a virtual space VS that is available for deciding the pixel value of each pixel of the processing target frame 20. The virtual space information 27 includes, for example, information regarding a viewpoint C for viewing the virtual space VS and information regarding motion of a game object O. Moreover, the virtual space information 27 may further include, for example, information regarding color and texture of the game object and information regarding intensity, color, and an illuminating direction of a light source. The virtual space information 27 may also be said to be information available for rendering the processing target frame 20. Note that the virtual space information 27 is not limited to those actually used for rendering the processing target frame 20. Further, in the present implementation, description is given by distinguishing between the virtual space information 27 and depth information described later, but the depth information may be treated as information being included in the virtual space information 27.

Here, the processing target frame 20 obtained as a result of rendering may not sufficiently include information regarding the virtual space VS; the accuracy of estimation based solely on the processing target frame 20 has limitations. That is, the virtual space information 27 may be used at the time of deciding the pixel value of each pixel of the processing target frame 20, but the virtual space information 27 itself would not remain in the processing target frame 20. For example, assuming that there are originally C pieces of information regarding the virtual space VS, in the process of deciding the pixel value (RGB value) of each pixel of the processing target frame 20, the C pieces of information are reduced to three pieces of information (RGB).

In view of this, the image processing system 1 according to the present implementation adopts a configuration of acquiring n-th auxiliary information 30_n by using n-th virtual space information 27_n that is information regarding the virtual space VS available for deciding the pixel value of each pixel of the n-th processing target frame 20_n. This allows utilization of the information regarding the virtual space VS, enabling a high quality estimated frame 24 to be obtained at high accuracy.

However, the virtual space information 27 may sometimes have insufficient reliability, and using such virtual space information 27 may occasionally result in a failure of acquiring an appearing pixel described later, at high accuracy. For example, when a fast-moving object is displayed in the processing target frame 20, the position accuracy of the appearing pixel generated based on motion information described later would decline, causing artifacts to be left in the estimated frame 24 in some cases. In view of this, the image processing system 1 according to the present implementation adopts a configuration of generating estimated appearing pixel information 37, which is to be described later, with use of the virtual space information 27 and generating auxiliary information 30 that is information regarding past frames, in reference to the estimated appearing pixel information 37. In the following description, functions implemented by the image processing system 1 are described in detail.

### 3. Functions implemented by image processing system

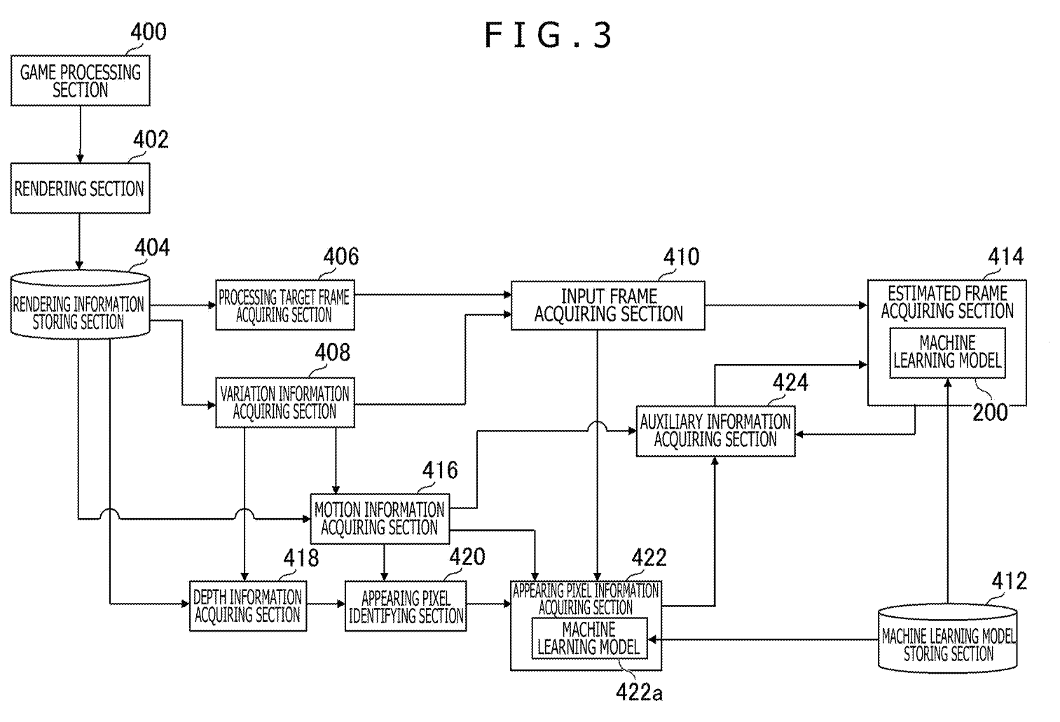

FIG. 3 is a functional block diagram illustrating an example of functions implemented by the image processing system 1. As illustrated in FIG. 3, in the image processing system 1, a game processing section 400, a rendering section 402, a rendering information storing section 404, a processing target frame acquiring section 406, a variation information acquiring section 408, an input frame acquiring section 410, a machine learning model storing section 412, an estimated frame acquiring section 414, a motion information acquiring section 416, a depth information acquiring section 418, an appearing pixel identifying section 420, an appearing pixel information acquiring section 422, and an auxiliary information acquiring section 424 are implemented. The game processing section 400, the rendering section 402, the processing target frame acquiring section 406, the variation information acquiring section 408, the input frame acquiring section 410, the estimated frame acquiring section 414, the motion information acquiring section 416, the depth information acquiring section 418, the appearing pixel identifying section 420, the appearing pixel information acquiring section 422, and the auxiliary information acquiring section 424 are mainly implemented by the control section 10. The rendering information storing section 404 and the machine learning model storing section 412 are mainly implemented by the storage section 12. Note that the game processing section 400, the rendering section 402, and the rendering information storing section 404 are functions provided by game software.

### Game processing section

The game processing section 400 executes various kinds of processing related to a game. The game processing section 400 executes, for example, processing of arranging the game object O in the virtual space VS, processing of causing the game object O to make an action or move, and processing of changing the viewpoint C for viewing the virtual space VS, according to the game program executed by the control section 10 and user input received by the operation section 16 (see FIG. 4). The game object O includes a primitive such as a polygon indicated by 3D data. The 3D data includes geometric information indicating the positions of vertices or the like, phase information indicating how to connect the vertices, and attribute information such as color.

### Rendering section

FIG. 4 is a diagram describing processing in the rendering section 402. The rendering section 402 generates first through N-th (N is a natural number equal to or greater than 2) processing target frames 20 by executing rendering (drawing process) of 3D data indicating one or more game objects O as viewed from the predetermined viewpoint C. The processing target frame 20 can also be said to be an image indicating, from the predetermined viewpoint C, the virtual space VS in which one or more game objects O represented by 3D data are arranged. The processing target frame 20 has a predetermined initial pixel count. The rendering section 402 executes rendering according to the results of various kinds of processing executed in the game processing section 400. Specifically, the rendering section 402 executes vertex processing (vertex shading) and pixel processing (pixel shading) in reference to 3D data indicating the game objects O arranged in the virtual space VS. The vertex processing includes a coordinate conversion process (perspective projection) of converting the coordinate system from a view coordinate system to a screen coordinate system. To a perspective projection matrix (camera matrix) used for the coordinate conversion process, numerical values related to the variation in the viewpoint C are added, as described later. The rendering section 402 may execute rendering in reference to light source information, depth information (depth buffer), texture information, normal line information, and the like. The rendering section 402 may execute processing of applying such effects as depth of field (DoF) and motion blur, for example, in addition to the processing described above. The processing to be executed by the rendering section 402 may be set as appropriate by the developer of the game software, for example. Here, the developer of the game software and the like may adjust the MIP of a texture according to the estimated pixel count of the estimated frame 24, for example. This can restrain noise such as moire from occurring in the estimated frame 24.

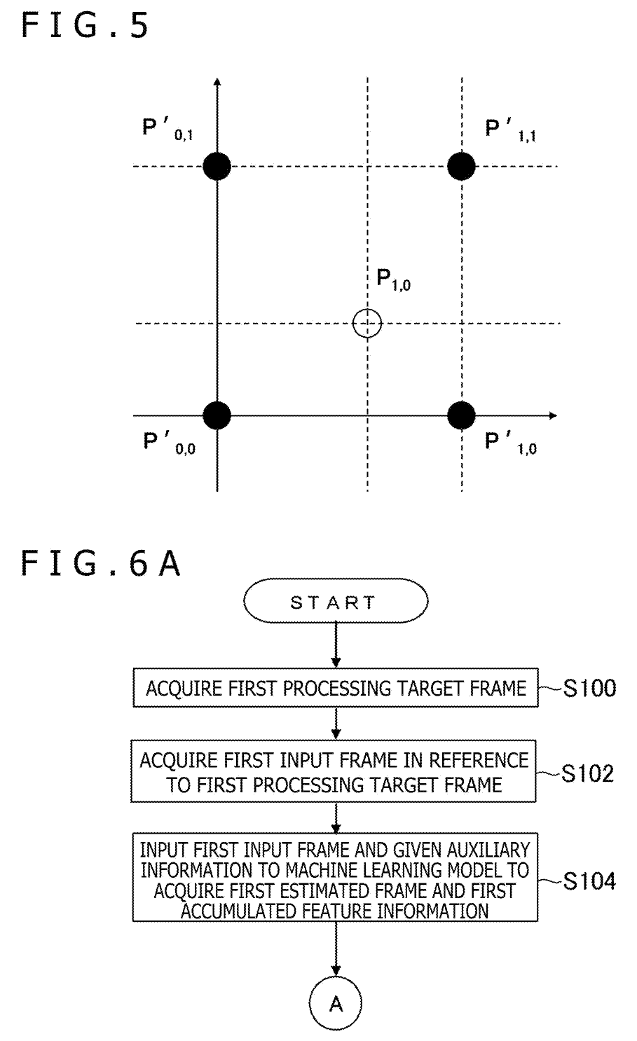

Here, the rendering section 402 generates each processing target frame 20 by executing rendering in such a manner that the viewpoint C varies for each processing target frame 20. In this instance, even if the game processing section 400 fixes the viewpoint C to a predetermined position, the rendering section 402 varies the viewpoint C for each processing target frame 20. As a result, as illustrated in FIG. 5, in each of the processing target frames 20_n, 20_n+1, and 20_n+2, the position of the displayed game object O varies. In other words, the rendering section 402 is applying jitter at the time of generating each processing target frame 20. Specifically, the rendering section 402 varies the viewpoint C for each processing target frame 20 by adding a numerical value that corresponds to the size of less than one pixel and that is different for each processing target frame 20 to the perspective projection matrix.

### Rendering information storing section

The rendering information storing section 404 stores information necessary for rendering processing in the rendering section 402 and information obtained as a result of the rendering processing. For example, the rendering information storing section 404 stores the processing target frames 20. Further, the rendering information storing section 404 stores the virtual space information 27 and variation information 29. Details of the virtual space information 27 and the variation information 29 are described later.

### Processing target frame acquiring section

The processing target frame acquiring section 406 acquires each of the first through N-th processing target frames 20. Specifically, the processing target frame acquiring section 406 acquires each of the first through N-th processing target frames 20 that are stored in the rendering information storing section 404.

### Variation information acquiring section

The variation information acquiring section 408 acquires pieces of first through N-th variation information 29 which are pieces of information concerning variation in the viewpoint C of each of the first through N-th processing target frames 20 in rendering. The variation information acquiring section 408 acquires the pieces of first through N-th variation information 29 stored in the rendering information storing section 404.

### Input frame acquiring section

The input frame acquiring section 410 acquires each of the first through N-th input frames 22 by generating, in reference to each of the processing target frames 20, input frames 22 that correspond to the respective processing target frames 20 and have an input pixel count equal to or greater than the initial pixel count. In the present implementation, each input frame 22 has an input pixel count that is greater than the initial pixel count. That is, in the present implementation, each input frame 22 is an image obtained by enlarging the processing target frame 20 corresponding to the relevant input frame 22.

Specifically, the input frame acquiring section 410 obtains, by interpolation, pixel values of positions corresponding to pre-variation pixels in the relevant processing target frame 20, in reference to the variation information 29 and the pixels of each processing target frame 20, and thereby generates each input frame 22. FIG. 5 is a diagram describing processing in the input frame acquiring section 410. FIG. 5 illustrates a case in which an n-th input frame 22_n is acquired. For example, as illustrated in FIG. 5, assuming that the pixel center of a certain pixel in the input frame 22_n which is intended to be acquired is (P1, 0), the input frame acquiring section 410 obtains the pixel value of (P1, 0) by bilinear interpolation, according to the coordinates and pixel values of each of the pixel centers (P’0, 0), (P’1, 0), (P’0, 1), and (P’1, 1) of the four pixels closest to (P1, 0) in the processing target frame 20_n. Here, (P’1, 0) is at a position deviated from (P1, 0) by an amount of variation indicated by the variation information 29. Pixel values of pixels newly generated by the enlargement processing are also similarly obtained. Note that, as the method of interpolation, in addition to bilinear interpolation, various kinds of known techniques including bicubic interpolation, Lanczos interpolation, and the like are available.

When rendering is executed in such a manner that the viewpoint C varies for each processing target frame 20, the amount of time-series information increases. Using the processing target frames 20 obtained in the manner described above (hereinafter referred to as “variation processing target frames”) for estimation makes it possible to obtain an estimated frame 24 with higher image quality.

Meanwhile, when a variation processing target frame (or an image obtained by enlarging this) is input to the machine learning model 200 without any change, the accuracy of estimation may decline due to an influence of variation in the viewpoint C.

In view of this, in the image processing system 1, as described above, pixel values of positions corresponding to pre-variation pixels in the relevant processing target frame 20 are obtained by interpolation in reference to the variation information 29 and pixels of each processing target frame 20, and each input frame 22 is thereby generated and input to the machine learning model 200. This corrects the influence of variation in the viewpoint C, making it possible to restrain the estimation accuracy from declining.

### Machine learning model storing section

The machine learning model storing section 412 stores the machine learning model 200, which is the first machine learning model, and a machine learning model 422a, which is a second machine learning model. Specifically, the machine learning model storing section 412 stores parameters of the machine learning models (the number of convolution layers, the number of nodes used for each convolution layer, the weight of each node, and the like).

### First machine learning model

The machine learning model 200 is a model that estimates an n-th estimated frame 24_n in reference to the n-th input frame 22_n. More specifically, the machine learning model 200 is a model that estimates the n-th estimated frame 24_n, in reference to the n-th input frame 22_n and the n-th auxiliary information 30_n. The machine learning model 200 is specifically a convolutional neural network (CNN). As the machine learning model 200, for example, known models including ResNet of a multilayer structure having a residual connection mechanism, U-Net of what is called an encoder/decoder type, and the like are available. As the machine learning model 200, the model described in NPL 1 may be used.

The machine learning model 200 is a model that has learned with use of a plurality of pieces of training data each including a learning input frame having an input pixel count and a learning estimated frame having an estimated pixel count. The machine learning model 200 includes the accumulated feature information output layer 202, an estimated frame output layer 204, and a convolution layer 206 (see FIG. 2).

The accumulated feature information output layer 202 receives, as input, the n-th input frame 22_n and the (n-1)-th auxiliary information 30_n-1, and outputs the n-th accumulated feature information 26_n indicating the features of the first through n-th input frames 22_n. The accumulated feature information output layer 202 may, for example, include one or more convolution layers. The accumulated feature information 26_n-1 is image information (information in bitmap format) having a pixel count equal to the input pixel count. The accumulated feature information 26_n-1 can also be said to be a feature map indicating the features of the first through (n-1)-th input frames 22.

Note that the accumulated feature information output layer 202 receives, as input, the first input frame 22_1 and given auxiliary information and outputs the first accumulated feature information 26_1. In the case of n = 1, since there has been no accumulated feature information 26, given auxiliary information prepared in advance is input to the accumulated feature information output layer 202, together with the first input frame 22_1.

The estimated frame output layer 204 receives, as input, the n-th accumulated feature information 26_n, and outputs the n-th estimated frame 24_n. The estimated frame output layer 204 may, similarly to the accumulated feature information output layer 202, include one or more convolution layers, for example. Alternatively, the estimated frame output layer 204 may include one or more transposed convolution layers (deconvolution layers).

The convolution layer 206 is a layer that reduces the number of channels of the accumulated feature information 26 while maintaining the pixel count thereof. The convolution layer 206 can reduce dimensions of the accumulated feature information 26, thus achieving lower computation costs. The convolution layer 206 is, for example, a convolution layer with a kernel count of 1 × 1, but is not limited thereto.

### Estimated frame acquiring section

The estimated frame acquiring section 414 acquires each of the first through N-th estimated frames 24 having an estimated pixel count that is greater than the initial pixel count and equal to or greater than the input pixel count, in reference to the first through N-th input frames 22, the pieces of first through N-th auxiliary information 30, and the machine learning model 200. In the present implementation, the estimated frame 24 has an estimated pixel count that is equal to the input pixel count.

### Motion information acquiring section

The motion information acquiring section 416 acquires (n-1)-th motion information which is information indicating the amount and direction of motion from the (n-1)-th processing target frame 20_n-1 to the n-th processing target frame 20_n. The (n-1)-th motion information is specifically image information indicating the amount and direction of motion of each pixel made between the (n-1)-th processing target frame 20_n-1 and the n-th processing target frame 20_n. Motion information is also called a motion vector. Motion information is information having a pixel count equal to the input pixel count. The motion information acquiring section 416 specifically acquires original motion information having a pixel count equal to the initial pixel count, and executes enlargement and interpolation processing on the original motion information to acquire motion information having pixels equal in number to the input pixel count.

### Depth information acquiring section

The depth information acquiring section 418 acquires (n-1)-th depth information indicating the depth of each pixel in the (n-1)-th processing target frame 20_n-1 and n-th depth information indicating the depth of each pixel in the n-th processing target frame 20_n. Depth information is also called a depth buffer or a Z buffer. Depth information is information having a pixel count equal to the input pixel count. Specifically, the depth information acquiring section 418 acquires original depth information having a pixel count equal to the initial pixel count, and executes enlargement and interpolation processing on the original depth information to acquire depth information having a pixel count equal to the input pixel count.

### Appearing pixel identifying section

The appearing pixel identifying section 420 identifies an n-th appearing pixel which is among the pixels of the n-th input frame 22_n and which is a pixel in which a whole or part of a game object O that is not displayed in the (n-1)-th input frame 22_n-1 is displayed, in reference to the (n-1)-th depth information and the n-th depth information. Specifically, the appearing pixel identifying section 420 identifies the n-th appearing pixel in reference to a difference between the (n-1)-th depth information and the n-th depth information. Note that the appearing pixel identifying section 420 may identify the n-th appearing pixel in reference to an (n-1)-th perspective projection matrix related to the (n-1)-th input frame 22_n-1 and an n-th perspective projection matrix related to the n-th input frame 22_n. Further, the appearing pixel identifying section 420 may identify the n-th appearing pixel by using the (n-1)-th motion information.

### Appearing pixel information acquiring section

The appearing pixel information acquiring section 422 acquires the estimated appearing pixel information 37 in reference to the input frame 22, the virtual space information 27, appearing pixel information which is image information indicating the position of the appearing pixel, and the machine learning model 422a. The estimated appearing pixel information 37 is information obtained by detailing the appearing pixel information acquired by the appearing pixel identifying section 420.

The machine learning model 422a is a model that estimates the estimated appearing pixel information 37 in reference to the input frame 22, the virtual space information 27, and the appearing pixel information. The machine learning model 422a is, for example, preferably a CNN. As the machine learning model 422a, for example, known models including ResNet of a multilayer structure having a residual connection mechanism, U-Net of what is called an encoder/decoder type, and the like are available.

The machine learning model 422a has a multilayer network structure in which a convolution layer 4221, a layer 4222 of a ReLU function (activation function), and the like are connected as illustrated in FIG. 2, and filters and parameters of functions used in these layers are the subject of learning. Note that two or more of the convolution layers 4211 and the like may be provided.

The machine learning model 422a is, for example, preferably a model that has learned with a plurality of pieces of training data including a learning input frame having an input pixel count, learning virtual space information (learning motion information, etc.) having a pixel count equal to the input pixel count, learning appearing pixel information having a pixel count equal to the input pixel count, and learning estimated appearing pixel information having a pixel count equal to the input pixel count. The machine learning model 422a is preferably one that has learned based on a loss between the output made when each piece of learning information is input and the learning estimated appearing pixel information. Here, the learning input frame is an image indicating, from a predetermined viewpoint, a learning virtual space in which one or more learning objects represented by learning 3D data are arranged. Moreover, the learning virtual space information is information regarding the learning virtual space available for deciding the pixel value of each pixel of the learning processing target frame. Further, the learning appearing pixel information is image information indicating the position of the learning appearing pixel.

The machine learning model 422a preferably outputs the estimated appearing pixel information 37 which has a pixel count of 4K and one channel, in reference to the input frame 22 (4K, 3ch), motion information (4K, 2ch) which is virtual space information, depth information (4K, 1ch), and appearing pixel information (4K, 1ch), for example. That is, the appearing pixel information acquiring section 422 preferably acquires the output in which the number of channels is reduced while the pixel count is maintained with respect to the input. This can suppress computation costs in the subsequent processing.

### Auxiliary information acquiring section

The auxiliary information acquiring section 424 acquires the auxiliary information 30 in reference to the virtual space information 27, the accumulated feature information 26, and the estimated appearing pixel information 37.

Specifically, the auxiliary information acquiring section 424 causes motion compensation to be applied to the (n-1)-th accumulated feature information 26_n-1 in reference to the (n-1)-th motion information and acquires the (n-1)-th auxiliary information 30_n-1 by using the n-th estimated appearing pixel information 37_n. Motion compensation refers to processing of, for example, moving a pixel of the (n-1)-th accumulated feature information 26_n-1 from a position x to a position x’, in a case where a pixel that had been present at the position x in the (n-1)-th processing target frame 20_n-1 moves to the position x’ in the n-th processing target frame 20_n. More specifically, the auxiliary information acquiring section 424 acquires the (n-1)-th auxiliary information 30_n-1 by setting the pixel value of each of the one or more pixels of the (n-1)-th accumulated feature information 26_n-1 for the pixel at a position to which movement has been made in accordance with the amount and direction of motion of the pixel, in reference to the (n-1)-th motion information.

In a case where any motion of the game object O has been made between the n-th processing target frame 20_n and the (n-1)-th processing target frame 20_n-1, if the n-th input frame 22_n and the (n-1)-th accumulated feature information 26_n-1 are input to the machine learning model 200 without any change and without taking into consideration the motion of the object at the time of acquiring the n-th estimated frame 24_n, a ghost phenomenon in which an afterimage of the game object O which had been displayed in the past frame is displayed may occur in the n-th estimated frame 24_n that is output. In view of this, in the image processing system 1, as described above, the (n-1)-th auxiliary information 30_n-1 is acquired by motion compensation being caused to be applied to the (n-1)-th accumulated feature information 26_n-1 in reference to the (n-1)-th motion information. This can restrain the abovementioned ghost phenomenon from occurring.

Moreover, the auxiliary information acquiring section 424 acquires the (n-1)-th auxiliary information 30_n-1 by causing the pixel value in the n-th estimated appearing pixel information 37_n in the (n-1)-th accumulated feature information 26_n-1 to be replaced with a predetermined value, in reference to the n-th estimated appearing pixel information 37_n. The predetermined value may, for example, be a fixed value such as zero (black), or a pixel value of the n-th appeari ng pixel in the n-th input frame 22_n.

### 4. Processing executed in image processing system

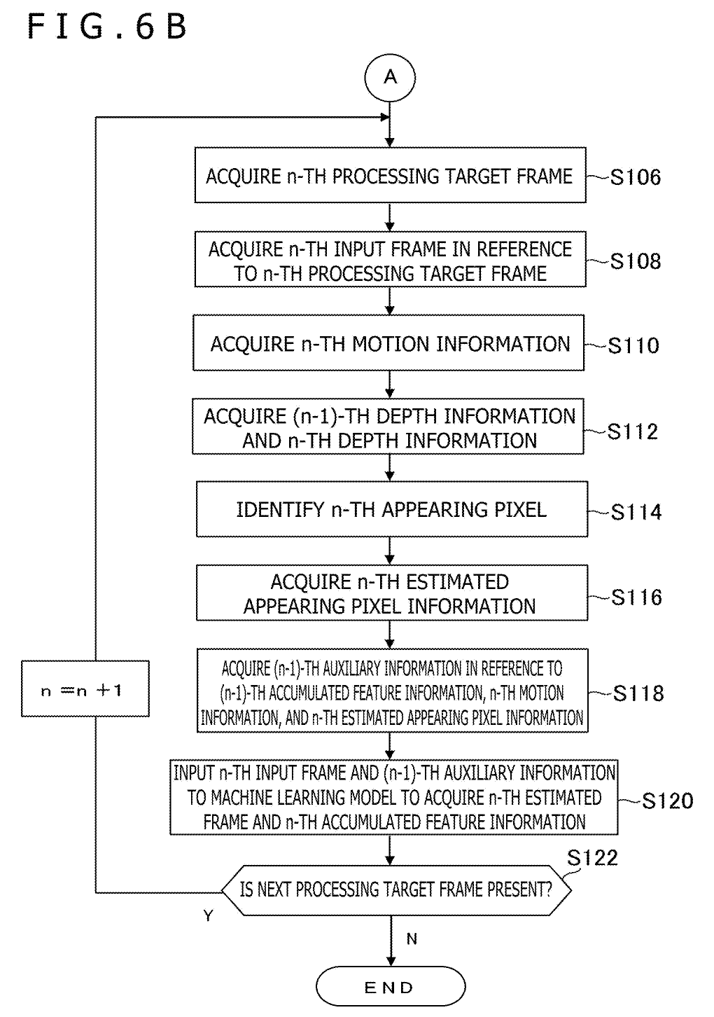

FIGS. 6A and 6B are each a flowchart illustrating an example of a flow of processing executed in the image processing system 1. The processing illustrated in FIGS. 6A and 6B is executed by the control section 10 operating in accordance with a program stored in the storage section 12.

### 1 Processing when n = 1

First, the control section 10 acquires a first processing target frame 20_1 (S100). The control section 10 then acquires a first input frame 22_1 in reference to the first processing target frame 20_1 (S102). Next, the control section 10 inputs the input frame 22_1 and given auxiliary information to the machine learning model 200 to acquire a first estimated frame 24_1 and first accumulated feature information 26_1 (S104).

### 2 Processing when n ≥ 2

The control section 10 acquires an n-th processing target frame 20_n (S106). The control section 10 then acquires an n-th input frame 22_n in reference to the n-th processing target frame 20_n (S108).

Next, the control section 10 acquires n-th motion information (S110). Thereafter, the control section 10 acquires (n-1)-th depth information and n-th depth information (S112) and identifies an n-th appearing pixel in reference to the (n-1)-th depth information and the n-th depth information (S114). Then, the control section 10 acquires n-th estimated appearing pixel information 37_n in reference to the n-th input frame 22, the n-th motion information, the n-th appearing pixel, and the machine learning model 422a (S116). The control section 10 subsequently acquires (n-1)-th auxiliary information 30_n-1 in reference to (n-1)-th accumulated feature information 26_n-1, (n-1)-th motion information, and the n-th estimated appearing pixel information 37_n (S118).

Thereafter, the control section 10 inputs the n-th input frame 22_n and the (n-1)-th auxiliary information 30_n-1 to the machine learning model 200 to acquire an n-th estimated frame 24_n and n-th accumulated feature information 26_n (S120).

Then, the control section 10 determines whether or not the next frame is present (S122). In the case of determining that the next frame is present (S122: Y), the control section 10 increments the value to n = n + 1 and repeats the processing in S108 through S120. In the case of determining that the next frame is not present (S122: N), the control section 10 ends the processing.

### Modification example

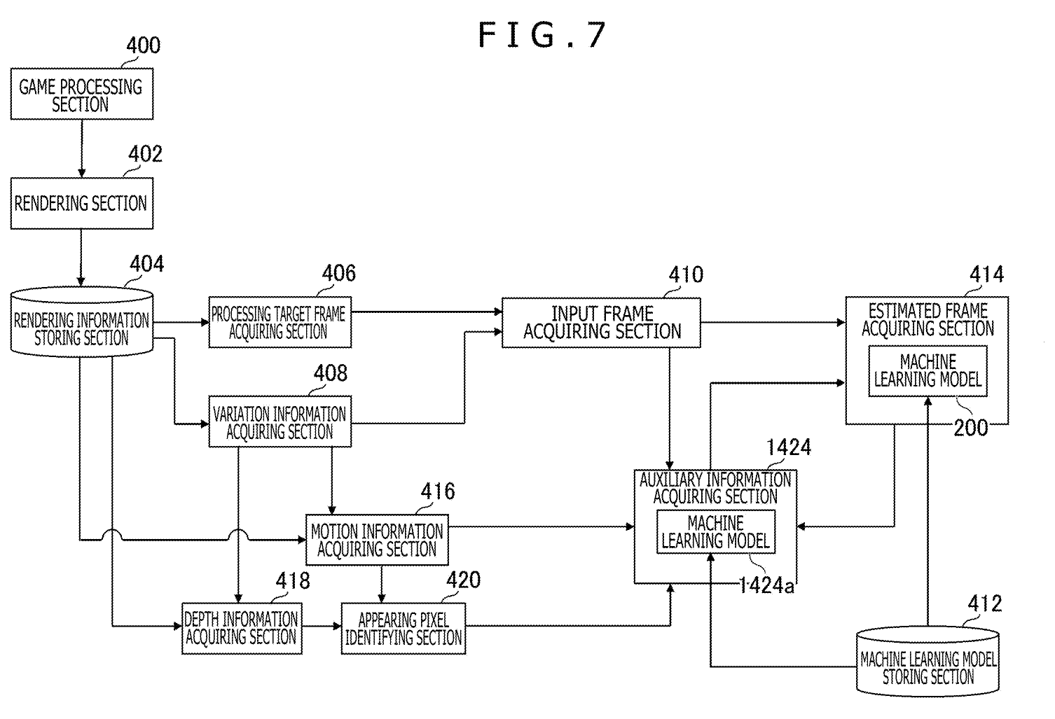

Next, a modification example of the present implementation is described with reference to FIG. 7. FIG. 7 is a functional block diagram illustrating an example of functions implemented by an image processing system according to the modification example. Note that the configurations having functions similar to those of the configurations described with reference to FIG. 4 are denoted by the same reference signs and description thereof will be omitted. In the modification example, an auxiliary information acquiring section 1424 includes a machine learning model 1422a, which is a second machine learning model. Further, the auxiliary information acquiring section 1424 acquires the auxiliary information 30 output from the machine learning model 1422a, by the input frame 22, the virtual space information 27, the appearing pixel information, and the accumulated feature information 26 being input to the machine learning model 1422a.

The machine learning model 1422a is, for example, preferably a model that has learned with a plurality of pieces of training data including a learning input frame having an input pixel count, learning virtual space information (learning motion information, etc.) having a pixel count equal to the input pixel count, learning appearing pixel information having a pixel count equal to the input pixel count, and learning auxiliary information having a pixel count equal to the input pixel count, for example. The machine learning model 1422a and the machine learning model 422a are preferably those that have learned based on a loss between the output made when each piece of learning information is input and the learning auxiliary information. Note that the learning auxiliary information is preferably information obtained by applying motion compensation to the learning accumulated feature information.

### 6. Summary

The image processing system 1 according to the present implementation and modification example described above estimates an n-th estimated frame 24_n with use of (n-1)-th accumulated feature information 26_n-1 indicating the features of first through (n-1)-th input frames 22. That is, in addition to information regarding the n-th processing target frame 20_n, information regarding the first through (n-1)-th processing target frames 20 can be used for estimation, so that the amount of information available for estimation is increased, making it possible to obtain a high quality estimated frame 24_n.

Further, the image processing system 1 according to the present implementation and the modification example acquires the n-th estimated frame 24_n in reference to the n-th input frame 22_n, the n-th virtual space information 27_n, and the machine learning model 200, so that information regarding the virtual space VS can be utilized, and a high quality estimated frame 24 can thus be obtained at high accuracy.

Furthermore, the image processing system 1 according to the present implementation and the modification example generates the auxiliary information 30 in reference to the input frame 22, the virtual space information 27, and the machine learning model 422a, thus improving the reliability of information regarding the past frames. As a result, the estimation accuracy of the estimated frame 24 improves.

Note that the present specification is not limited to the implementation and modification example described above. For example, the present implementation and the modification example have illustrated a case where the input pixel count is greater than the initial pixel count and equal to the estimated pixel count, but the input pixel count may be equal to the initial pixel count and the estimated pixel count may be greater than the input pixel count. That is, the input frame 22 may not necessarily be obtained by enlargement of the processing target frame 20.

What is claimed is:

1. An image processing system comprising:
one or more computer processors; and
one or more non-transitory computer-readable media that store instructions which, when executed by the one or more computer processors, cause the one or more computer processors to perform operations comprising;
obtaining an n-th processing target frame, n being a natural number equal to or greater than 2, the target frame indicating, from a predetermined viewpoint, a virtual space in which one or more objects represented by three-dimensional data are arranged,
obtaining an n-th input frame in reference to the n-th processing target frame,
inputting the n-th input frame and (n-1)-th auxiliary information regarding features of first through (n-1)-th input frames to a first machine learning model to obtain n-th accumulated feature information indicating features of the first through n-th input frames that is to be output from the first machine learning model and an n-th estimated frame,
obtaining n-th virtual space information that is information regarding the virtual space available for deciding a pixel value of each pixel of the n-th processing target frame,
obtaining (n-1)-th depth information indicating a depth of each pixel of an (n-1)-th processing target frame and n-th depth information indicating a depth of each pixel of the n-th processing target frame,
identifying an n-th appearing pixel that is a pixel among pixels of the n-th processing target frame and that is a pixel in which a whole or part of the object that is not displayed in the (n-1)-th processing target frame is displayed, in reference to the (n-1)-th depth information and the n-th depth information, and
obtaining n-th auxiliary information in reference to at least the n-th appearing pixel, the n-th virtual space information, the n-th accumulated feature information, and a second machine learning model.

2. The image processing system of claim 1, wherein the operations comprise:
inputting the n-th appearing pixel and the n-th virtual space information to the second machine learning model to obtaining n-th estimated appearing pixel information that is to be output from the second machine learning model, and
obtaining n-th auxiliary information in reference to the n-th estimated appearing pixel information and the n-th accumulated feature information.

3. The image processing system of claim 2, wherein the operations comprise:
inputting the n-th input frame in addition to the n-th appearing pixel and the n-th virtual space information to the second machine learning model, and
obtaining the n-th estimated appearing pixel information that is output from the second machine learning model.

4. The image processing system of claim 1, wherein the operations comprise:
inputting the n-th appearing pixel, the n-th virtual space information, and the n-th accumulated feature information to the second machine learning model, and
obtaining the n-th auxiliary information that is output from the second machine learning model.

5. The image processing system of claim 4, wherein the operations comprise:
obtaining the n-th input frame in addition to the n-th appearing pixel, the n-th virtual space information, and the n-th accumulated feature information to the second machine learning model, and
obtaining the n-th auxiliary information that is output from the second machine learning model.

6. The image processing system of claim 1, wherein the n-th virtual space information includes n-th motion information indicating an amount and a direction of motion of the object displayed in each pixel of the (n-1)-th input frame from the (n-1)-th input frame to the n-th input frame.

7. The image processing system of claim 1, wherein the target frame is a video frame of a video game user interface.

8. One or more non-transitory computer-readable media that store instructions which, when executed by one or more computer processors, cause the one or more computer processors to perform operations comprising;
obtaining an n-th processing target frame, n being a natural number equal to or greater than 2, the target frame indicating, from a predetermined viewpoint, a virtual space in which one or more objects represented by three-dimensional data are arranged,
obtaining an n-th input frame in reference to the n-th processing target frame,
inputting the n-th input frame and (n-1)-th auxiliary information regarding features of first through (n-1)-th input frames to a first machine learning model to obtain n-th accumulated feature information indicating features of the first through n-th input frames that is to be output from the first machine learning model and an n-th estimated frame,
obtaining n-th virtual space information that is information regarding the virtual space available for deciding a pixel value of each pixel of the n-th processing target frame,
obtaining (n-1)-th depth information indicating a depth of each pixel of an (n-1)-th processing target frame and n-th depth information indicating a depth of each pixel of the n-th processing target frame,
identifying an n-th appearing pixel that is a pixel among pixels of the n-th processing target frame and that is a pixel in which a whole or part of the object that is not displayed in the (n-1)-th processing target frame is displayed, in reference to the (n-1)-th depth information and the n-th depth information, and
obtaining n-th auxiliary information in reference to at least the n-th appearing pixel, the n-th virtual space information, the n-th accumulated feature information, and a second machine learning model.

9. The media of claim 8, wherein the operations comprise:
inputting the n-th appearing pixel and the n-th virtual space information to the second machine learning model to obtaining n-th estimated appearing pixel information that is to be output from the second machine learning model, and
obtaining n-th auxiliary information in reference to the n-th estimated appearing pixel information and the n-th accumulated feature information.

10. The media of claim 9, wherein the operations comprise:
inputting the n-th input frame in addition to the n-th appearing pixel and the n-th virtual space information to the second machine learning model, and
obtaining the n-th estimated appearing pixel information that is output from the second machine learning model.

11. The media of claim 8, wherein the operations comprise:
inputting the n-th appearing pixel, the n-th virtual space information, and the n-th accumulated feature information to the second machine learning model, and
obtaining the n-th auxiliary information that is output from the second machine learning model.

12. The media of claim 11, wherein the operations comprise:
obtaining the n-th input frame in addition to the n-th appearing pixel, the n-th virtual space information, and the n-th accumulated feature information to the second machine learning model, and
obtaining the n-th auxiliary information that is output from the second machine learning model.

13. The media of claim 8, wherein the n-th virtual space information includes n-th motion information indicating an amount and a direction of motion of the object displayed in each pixel of the (n-1)-th input frame from the (n-1)-th input frame to the n-th input frame.

14. The media of claim 8, wherein the target frame is a video frame of a video game user interface.

15. A computer-implemented method comprising:
obtaining an n-th processing target frame, n being a natural number equal to or greater than 2, the target frame indicating, from a predetermined viewpoint, a virtual space in which one or more objects represented by three-dimensional data are arranged,
obtaining an n-th input frame in reference to the n-th processing target frame,
inputting the n-th input frame and (n-1)-th auxiliary information regarding features of first through (n-1)-th input frames to a first machine learning model to obtain n-th accumulated feature information indicating features of the first through n-th input frames that is to be output from the first machine learning model and an n-th estimated frame,
obtaining n-th virtual space information that is information regarding the virtual space available for deciding a pixel value of each pixel of the n-th processing target frame
obtaining (n-1)-th depth information indicating a depth of each pixel of an (n-1)-th processing target frame and n-th depth information indicating a depth of each pixel of the n-th processing target frame,
identifying an n-th appearing pixel that is a pixel among pixels of the n-th processing target frame and that is a pixel in which a whole or part of the object that is not displayed in the (n-1)-th processing target frame is displayed, in reference to the (n-1)-th depth information and the n-th depth information, and
obtaining n-th auxiliary information in reference to at least the n-th appearing pixel, the n-th virtual space information, the n-th accumulated feature information, and a second machine learning model.

16. The method of claim 15, wherein the operations comprise:
inputting the n-th appearing pixel and the n-th virtual space information to the second machine learning model to obtaining n-th estimated appearing pixel information that is to be output from the second machine learning model, and
obtaining n-th auxiliary information in reference to the n-th estimated appearing pixel information and the n-th accumulated feature information.

17. The method of claim 16, wherein the operations comprise:
inputting the n-th input frame in addition to the n-th appearing pixel and the n-th virtual space information to the second machine learning model, and
obtaining the n-th estimated appearing pixel information that is output from the second machine learning model.

18. The method of claim 15, comprising:
inputting the n-th appearing pixel, the n-th virtual space information, and the n-th accumulated feature information to the second machine learning model, and
obtaining the n-th auxiliary information that is output from the second machine learning model.

19. The method of claim 18, comprising:
obtaining the n-th input frame in addition to the n-th appearing pixel, the n-th virtual space information, and the n-th accumulated feature information to the second machine learning model, and
obtaining the n-th auxiliary information that is output from the second machine learning model.

20. The method of claim 15, wherein the n-th virtual space information includes n-th motion information indicating an amount and a direction of motion of the object displayed in each pixel of the (n-1)-th input frame from the (n-1)-th input frame to the n-th input frame.
